(19) United States
(12) Patent Application Publication
(10) Pub. No.: US 2015/0291251 A1
(43) Pub. Date: Oct. 15, 2015

(54) HYDRAULIC ADJUSTMENT DEVICE FOR HYDRAULIC BREAK

(71) Applicant: Ko-Min Lin, Changhua (TW)

(72) Inventor: Ko-Min Lin, Changhua (TW)

(73) Assignee: GG CO., LTD., CHANGHUA (TW)

(21) Appl. No.: 14/250,295

(22) Filed: Apr. 10, 2014

(51) Int. Cl. B62L 3/00; B62L 3/02

(52) U.S. Cl. CPC B62L 3/00; B62L 3/023

(57) ABSTRACT

A hydraulic adjustment device for a hydraulic break may include a break clamp, a piston, a resilient unit and a knob. The break clamp has a receiving space to receive a break pad and one side of the receiving space has a oil chamber on the break clamp. An arm is formed corresponding to an opening of the oil chamber and a break line passes through a moving end of the arm, and the break line extends to connect the break clamp and a handle of a bicycle. The piston restores to its original position with the resilient force of the resilient unit, and the knob is mounted on the rod of the positioning portion to conduct fine-tuning of the piston through the rod.

### FIELD OF THE INVENTION

This invention relates to a hydraulic fine-tuning device for a hydraulic break, and more particularly to an oil chamber on the break clamp to store the hydraulic oil therein.

### BACKGROUND OF THE INVENTION

Conventional hydraulic break may include a break clamp on the bicycle rack and a piston driven by hydraulic oil is in the break clamp. An oil container providing hydraulic oil is disposed on the handle of the break, and a hydraulic channel is disposed between the oil container and piston to transport the hydraulic oil.

However, conventional hydraulic break may be disadvantageous because (i) the oil container is disposed on the handle may decrease the aesthetic value of the handle; and (ii) the oil contain has a certain size and may not be suitable for every bicycles, especially for road bicycles and racing bicycles with curved handles. Therefore, there remains a need for a new and improved hydraulic break to overcome the problems stated above.

### SUMMARY OF THE INVENTION

Conventional hydraulic break may be disadvantageous because (i) the oil container is disposed on the handle may decrease the aesthetic value of the handle; and (ii) the oil contain has a certain size and may not be suitable for every bicycles, especially for road bicycles and racing bicycles with curved handles. In the present invention, a hydraulic adjustment device for a hydraulic break may include a break clamp, a piston, a resilient unit and a knob. The break clamp has a receiving space to receive a break pad and one side of the receiving space has a oil chamber on the break clamp, and the oil chamber and the receiving space are communicated with a hole, so that the oil stored in the oil chamber can flow to the receiving space through the hole or flow back to tighten or release the break pad. An arm is formed corresponding to an opening of the oil chamber and a break line passes through a moving end of the arm, and the break line extends to connect the break clamp and a handle of a bicycle, and a positioning portion that has a screw hole is disposed on the arm. A rod extends from the piston, which is disposed in the oil chamber after the resilient unit is disposed therein, and the rod engages with the screw hole of the arm. With the resilient force of the resilient unit, the piston can restore to its original position. The knob is mounted on the rod of the positioning portion to fine-tune the piston through the rod.

Comparing with conventional arts, the present invention is advantageous because (i) the oil chamber to store the hydraulic oil is formed on the break clamp, so the aesthetic value of the handle of the break can be enhanced; and (ii) the oil chamber is formed as one unit on the break clamp, so the handle of the break does not need an extra space for the oil chamber to avoid the trouble of installing an oil container.

### BRIEF DESCRIPTION OF THE DRAWINGS

FIG. 1 illustrates a three-dimensional view of the present invention.

FIG. 2 illustrates a three-dimensional exploded view of the present invention.

FIG. 3 illustrates a sectional view of the present invention.

FIG. 4 illustrates a schematic view of the break in the present invention.

FIG. 5 illustrates a schematic view of fine-tuning in the present invention.

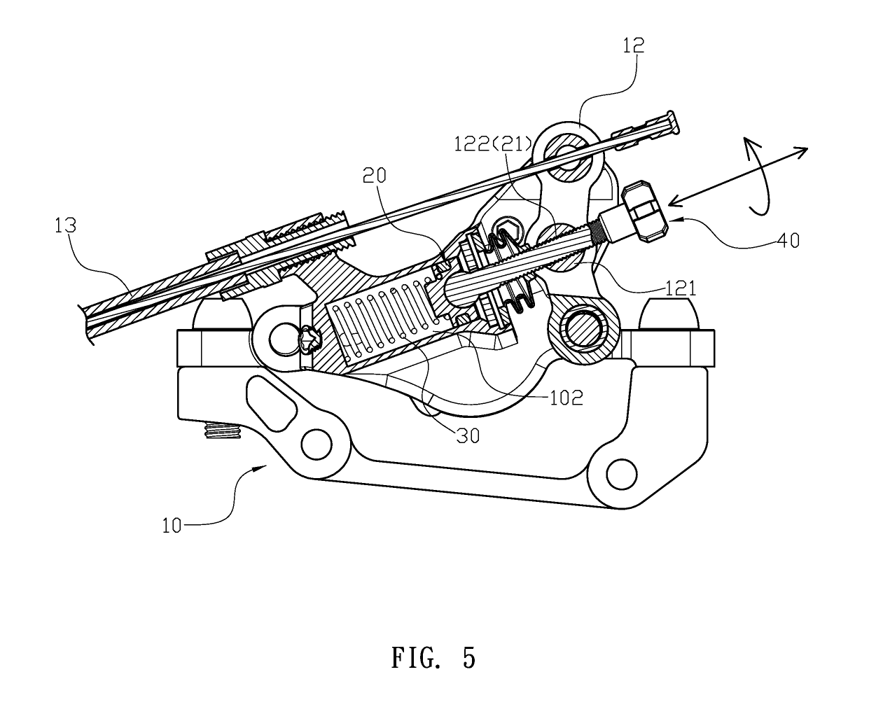

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

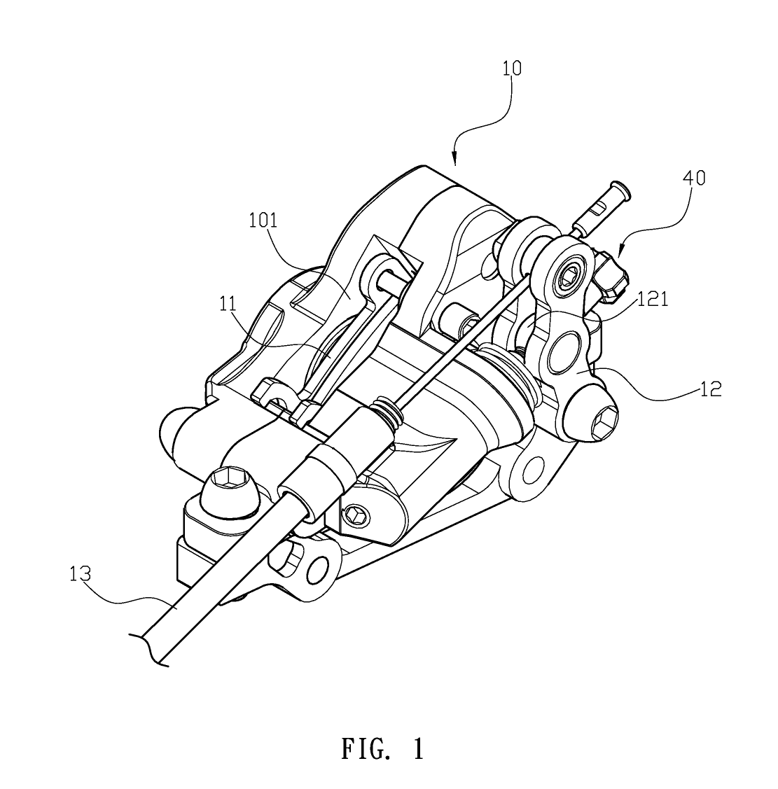

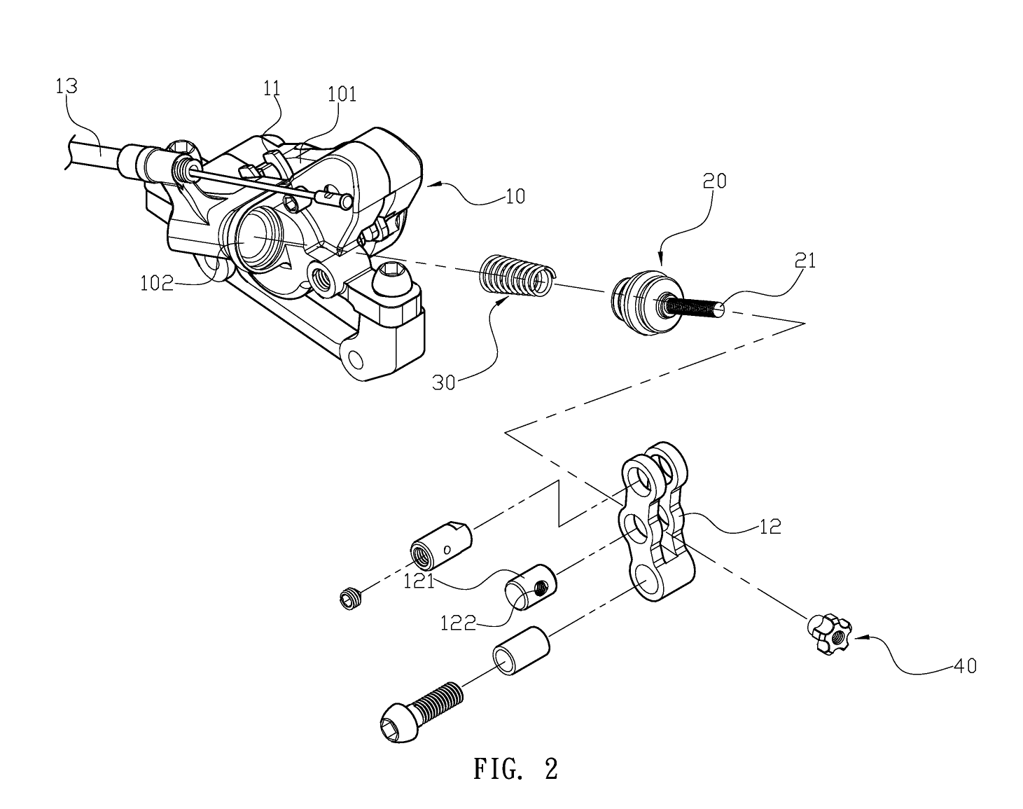

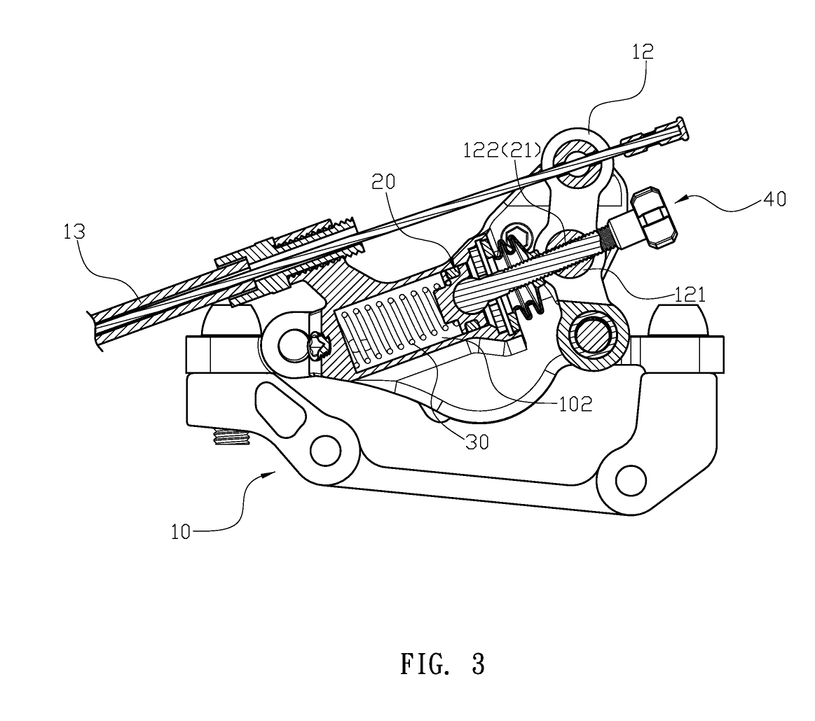

Referring to FIGS. 1 to 3, a hydraulic adjustment device for a hydraulic break may include a break clamp 10, a piston 20, a resilient unit 30 and a knob 40. The break clamp 10 has a receiving space 101 to receive a break pad 11 and one side of the receiving space 101 has a oil chamber 102 on the break clamp 10, and the oil chamber 102 and the receiving space 101 are communicated with a hole, so that the oil stored in the oil chamber 102 can flow to the receiving space 101 through the hole or flow back to tighten or release the break pad 11. An arm 12 is formed corresponding to an opening of the oil chamber 102 and a break line 13 passes through a moving end of the arm, and the break line 13 extends to connect the break clamp 10 and a handle of a bicycle, and a positioning portion 121 that has a screw hole 122 is disposed on the arm 12. A rod 21 extends from the piston 20, which is disposed in the oil chamber 102 after the resilient unit 30 is disposed therein, and the rod 21 engages with the screw hole 122 of the arm 12. With the resilient force of the resilient unit 30, the piston 20 can restore to its original position. The knob 40 is mounted on the rod 21 of the positioning portion 121 to fine-tune the piston 20 through the rod 21.

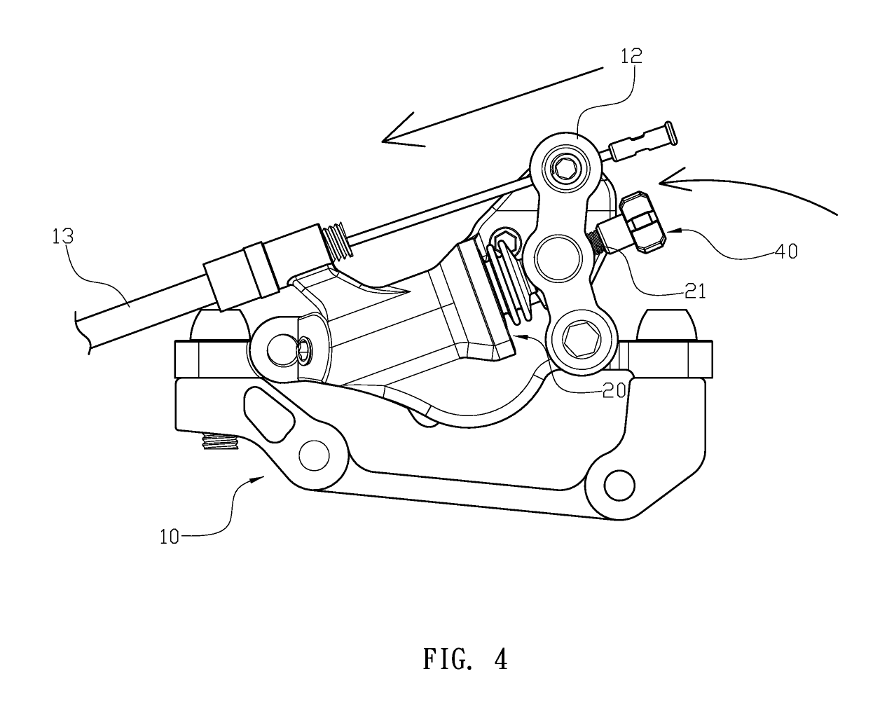

When in use, the handle of the break is pressed so the break line 13 drives the arm 12 to move toward the oil chamber 102 (see FIG. 4), namely driving the piston 20 to move horizontally through the arm 12, so the hydraulic oil stored in the oil chamber 102 can be squeezed out by the piston 20 to drive the break pad 11 in the receiving space 101. When the handle of the break is released, the resilient unit 30 can push the piston 20 back to its original position. Furthermore, the knob 40 is used to drive the piston 20 to axially move on the positioning portion 121 to conduct fine-tuning of the break.

According to the embodiments discussed above, the present invention is advantageous because (i) the oil chamber 102 to store the hydraulic oil is formed on the break clamp 10, so the aesthetic value of the handle of the break can be enhanced; and (ii) the oil chamber 102 is formed as one unit on the break clamp 10, so the handle of the break does not need an extra space for the oil chamber to avoid the trouble of installing an oil container.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A hydraulic adjustment device for a hydraulic break may include a break clamp, a piston, a resilient unit and a knob,
wherein the break clamp has a receiving space to receive a break pad and one side of the receiving space has a oil chamber on the break clamp, and the oil chamber and the receiving space are communicated with a hole, so that the oil stored in the oil chamber is configured to flow to the receiving space through the hole or flow back to tighten or release the break pad,
wherein an arm is formed corresponding to an opening of the oil chamber and a break line passes through a moving end of the arm, and the break line extends to connect the break clamp and a handle of a bicycle, and a positioning portion that has a screw hole is disposed on the arm,
wherein a rod extends from the piston, which is disposed in the oil chamber after the resilient unit is disposed therein, and the rod engages with the screw hole of the arm, and
wherein the piston restores to its original position with the resilient force of the resilient unit, and the knob is mounted on the rod of the positioning portion to conduct fine-tuning of the piston through the rod.
